(19) United States
(12) Patent Application Publication
(10) Pub. No.: US 2006/0084754 A1
(43) Pub. Date: Apr. 20, 2006

(54) Coating compound for the production of a hydrophilic coating

(75) Inventors: Erik Woldt, Lippstadt (DE); Stephan Schmidt, Lippstadt (DE)

Correspondence Address: HUSCH & EPPENBERGER, LLC, 190 CARONDELET PLAZA, SUITE 600, ST. LOUIS, MO, 63105-3441, US

(73) Assignee: HELLA KG HUECK & CO., Lippstadt (DE)

(21) Appl. No.: 11/241,457

(22) Filed: Sep. 30, 2005

(30) Foreign Application Priority Data
Oct. 20, 2004 (DE) DE 102004051034.2

(51) Int. Cl. C08L 83/04

(52) U.S. Cl. 524/588

(57) ABSTRACT

The present invention relates to a coating composition for the production of a hydrophilic coating on a plastic substrate comprising phase-segregated compartments of the following compound classes: a) at least one polyaromatic blocks having a molecular weight of about 1,000 to about 20,000 g/mole, b) at least one polyorganosiloxane block having a molecular weight of about 200 to about 50,000 g/mole and c) at least one hydrophilic polyether block having a molecular weight of about 100 to about 50,000 g/mole.

### STATE OF THE ART

The present invention relates to a coating composition for the production of a hydrophilic coating on a plastic substrate.

During operation of headlamp systems, cycles having varying temperatures and internal moistures are passed through. Condensable materials, such as water, but also other materials, are thus precipitated at cold points of the system. In particular the end plate of the headlamp then shows visible coverings. Since water does not spread well on most plastics, the condensation of water is particularly noticeable.

If the presence of these materials cannot be prevented, attempts have been made not to let them appear as visible coverings.

Hence, lacquering with hydrophilic additives has been recommended by various sides. Since these lacquers have to have a certain tenacity and adhesion to bisphenol-A polycarbonate, hydrophilic additives which are soluble to a limited extent are present therein. The problem is that often “bleeding” or washing out of these hydrophilic materials may be observed. Bleeding is intensified particularly by covering with water.

The efficiency of the coatings is lost by contamination with other organic and inorganic materials, in particular materials with lower surface tension than the hydrophilic additives coat them irreversibly and lead to the formation of undesirable small wetting angles during condensation of water. These materials may be polydimethylsiloxanes and separating agents, such as fatty acid esters of pentaerythritol and other polyalcohols.

The efficiency of such a coating is visibly reduced by these two mechanisms.

A further requirement is therefore the ability to be tolerant to various contaminants and not to permit bleeding of the hydrophilic groups. Furthermore, good adhesion to the bisphenol-A polycarbonate has to be guaranteed.

A further requirement consists in being clearly transparent in the wavelength range of visible light.

The object of the present invention consists in providing a coating system which shows good binding to the plastic substrate and likewise contains groups which on the one hand absorb the above-mentioned contaminants and on the other hand hydrophilic groups which may be moved rapidly on the surface when water is added there.

The solution to this object provides a coating composition of the type mentioned in the introduction, which contains phase-segregated compartments of the following compound classes:

a. polyaromatic blocks having a molecular weight of 1,000-20,000 g/mole,

b. polyorganosiloxane blocks having a molecular weight of 200-50,000 g/mole,

c. hydrophilic polyether blocks having a molecular weight of 100-50,000 g/mole,

and optionally

d. polyolefin blocks having a molecular weight of 2,000-500,000 g/mole.

These individual compartments of a compound assume various tasks in order to fulfil the overall function to be achieved.

The materials a. on the one hand and b./c./d. on the other hand are thermodynamically not compatible with one another in the indicated molecular weight ranges and have spontaneous segregation of the phases. This multi-phase nature may be detected by transmission electron microscopy after contrasting and with the aid of dynamic-mechanical spectroscopy, the glass transition temperatures of the individual ranges delimited from one another may be determined as maxima of the loss modulus G″ and of the loss factor tan(δ) when these ranges differ from one another as regards their characteristic relaxation times.

It is important in this context that the individual phases spontaneously form domains in the nanometer range. This guarantees that the diffusion paths of the participating corresponding absorber groups and contaminants are kept small. Furthermore, the absorbers have to be present in the elastomeric state, so that the participating absorber groups are able to execute cooperative rearrangements in the region of several nm³. In order to illustrate the order of magnitude on molecular scales, about 40 —CH₂— sequences in a polymer chain coordinated with six further chains correspond to this volume. The typical relaxation times for such processes may be estimated with the aid of dynamic-mechanical spectroscopy.

For thermodynamic reasons, the hydrophilic segments cannot be found on the surface of the dry coating. Indeed, the polyorganosiloxane, preferably polydimethylsiloxane (PDMS) will be held there. The hydrophilic polyethers are preferably polyethylene glycol or copolycondensates of ethylene glycol with other polyhydric alcohols. However, if the hydrophilic polyether or the polyethylene glycol (PEG) is bound to the PDMS via short spacer molecules, during the formation of liquid water by dewing on the layer, the PEG is orientated into the aqueous phase and will lead to running or spreading of the water droplets to form a water film.

This in-situ condition occurs, since the relaxation times in the range of such small molecular parts and the participating partners PEG and PDMS are significantly less than one second. Binding of the hydrophilic groups to an elastomeric phase should ensure that these groups remain mobile in the bulk which is close to the surface.

The PDMS absorb diverse contaminants, such as other silicones, without reducing the efficiency of the layer.

However, these material classes do not have good adhesion to the plastic of the substrate, for example polycarbonate and therefore will not be able to be used as a suitable coating system without groups orientated specifically to polycarbonate.

It is known from other tests that polystyrene polymers may have good adhesion, for example to polycarbonate.

Coupling of the individual functional chains to one another is thus of interest. In the present case, one exemplary embodiment is executed, the raw materials of which originate from commercial polymers which are already available.

For example styrene block copolymers of the type A-B-A with elastomeric central blocks are known for many applications. These block copolymers contain the polyaromatic block required for this application, it may provide good adhesion, in particular to the polycarbonate, in itself or with the aid of further polyaromatic resins which are soluble therein.

The elastomeric central block should preferably be suitable to be grafted with an adequate number of PDMS chains and PEG chains. For example coupling via an imide bridge, which on the one hand is formed from maleic acid anhydride grafted onto the elastomeric central block and on the other hand is formed from a primary amine radical on the PEG or PDMS chains and has good stability, is suitable for this.

The PDMS and PEG chains may be used, for example in the form of a copolymer. The spatial proximity of the compartments formed from these groups required in particular, is thus provided.

Further materials may advantageously be used, so that certain properties of the coating may be achieved. These include, for example:
Stabilisers to degradation by elevated temperature, for example sterically hindered phenols and amines and light-protecting agents, such as benzotriazoles.
Resins which are soluble predominantly in one of the phases and do not disturb the segregation, for example aliphatic hydrocarbon polymers for the elastomeric phases, also with low aromatic contents, and aromatic resins having a molecular weight not above twice the molecular weight of the polystyrene blocks of the block copolymer.

The latter serve for adhesion modification and viscosity reduction during compounding and processing.
Solvents which permit processing as a lacquer system.

The polyaromatic blocks of compound class a) preferably have a molecular weight of about 4,000 to about 10,000 g/mole in the compound of the invention serving as coating composition. The polyorganosiloxane blocks of compound class b), polydimethylsiloxane blocks are preferably used, preferably have a molecular weight of about 500 to about 5,000 g/mole. The hydrophilic polyether blocks of compound class c), polyethylene glycol blocks are preferably used, preferably have a molecular weight of about 500 to about 20,000 g/mole. The polyolefin blocks of compound class d), which are optionally used, preferably have a molecular weight of about 20,000 to about 100,000 g/mole.

The coating composition preferably comprises a polymer, the hydrophilic groups of which are bound to an elastomeric phase which has an intrinsic glass transition as a maximum of the loss modulus at ω=10/s determined at temperatures less than −10° C. The coating composition also comprises at least one polymer, the elastomeric phase of which is bound to a hard phase which is present in the glass state at room temperature and which has an intrinsic glass transition as a maximum of the loss modulus at ω=10/s determined at temperatures greater than 50° C.

At least one polymer is preferably used, the double-phase nature of which can be detected by dynamic-mechanical spectroscopy. The polymer is preferably contamination-tolerant with respect to PDMS (polydimethylsiloxane).

The invention relates in particular to the use of a coating composition of the aforementioned type as a hydrophilic coating on a substrate, in particular a substrate which comprises polycarbonate. The coating composition of the invention is particularly suitable for use in the coating of motor vehicle parts, preferably of plastic end plates in motor vehicle headlamps.

### DRAWINGS

The present invention is described in more detail below using an exemplary embodiment with reference to the attached graphics.

FIG. 1 shows graphs of the loss moduli G′, G″ recorded in a mechanical-dynamic spectrometer and of the loss factor tan(δ) as a function of the temperature.

### DESCRIPTION OF THE EXEMPLARY EMBODIMENTS

### EXAMPLE

The following materials are used as raw materials:
Styrene block copolymers: block polystyrene-block polyethylene butylene-block polystyrene grafted with about 7 moles (maleic acid anhydride)/mole (styrene block copolymer), an average molecular weight of 120 kmoles/g, determined with the aid of gel-permeation chromatography and calibrated against PS standards, and having a polystyrene content of 28%.
Aromatic end block resin having a zero shear viscosity of 2,109 mPas determined at 150° C., and a number-average molecular weight of 1.2 kmoles/g.
Phenolic antioxidant pentaerythritol-tetrakis[3,(3,5-di-tertiary-butyl-4-hydroxyhenyl)-propionate].
PDMS-aminoethylaminopropyl-block ethylene oxide-block propylene oxide copolymer having a viscosity of 410 mPas at room temperature.
   Production of the Compound:

29.3 g of an aromatic end block resin and 1.0 g of a sterically hindered phenol as processing stabiliser were placed initially in a double-shaft kneader preheated at 160° C.

After melting, 160.0 g of the maleic acid anhydride-grafted styrene block copolymer were added in two portions 5 minutes apart. Since a homogeneous compound is achieved, the amine-containing PDMS-PEG copolymer (42.0 g) is added dropwise, so that the addition does not take place more quickly than the consumption via imidisation. This guarantees that the composition does not lose its kneadability. After the addition, a vacuum is applied for 10 minutes and the composition is removed from the kneader after this time. N₂ is used as protective gas.

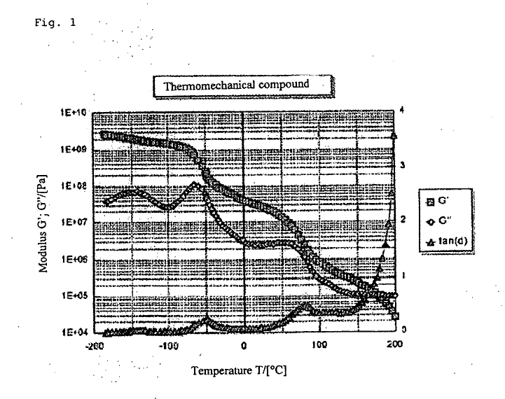

Samples are cut off from the material for model investigation of suitability and a film is pressed against polycarbonate sheets on a hot press. The upper side of the hot press consists of PTFE. If the coating is wetted with water, the latter spreads spontaneously to form a film. After storage in PDMS-containing atmosphere, the coating is likewise able to spread the water according to task. A sample 12×19×2.6 mm³ was shaped from the compound at 160° C. and investigated in the linear viscoelastic range in a mechanical-dynamic spectrometer Physica UDS200. The measuring frequency was ω=10/s. The investigation comprised a temperature range from −185° C. to +200° C. The graph obtained is shown in FIG. 1.

The comparison with the raw materials shows how the phase behaviour has been changed by the modification.
The β-relaxation stemming from the elastomeric central block occurs at −150° C. to −170° C. and shows no differences with respect to the raw material.

This is understandable inasmuch as the size scales of the functional groups contacted therewith lie in the range of a few binding lengths and are not to be influenced by grafting of whole molecule chains at a different site in the copolymer.
If the α-relaxation is observed (glass transition temperature) at −60° C. to −50° C., it is established that an individual transition exists between that at −75° C. for PDMS and at −45° C. of the pure elastomeric central block of the raw materials. It is possible to interpret therefrom that in the size scale range of the segments responsible for glass transition, largely homogeneous distribution of the functional groups PDMS and elastomeric central block exists, or has been forced by the graft reaction.
At about 80° C. α-relaxation of the aromatic end blocks occurs. This shows that (at least) the double-phase nature is retained.
The double-phase nature is resolved in an order/disorder transition, and specifically from 130° C. upwards. The fact that no crosslinked elastomer was formed by the modification may be shown by the viscoelastic spectrum at 150° C. No minimum of damping is attempted at low frequencies. At 200° C. the material is characterised as capable of application, thermoplastic with tan(δ)>3.

From these findings it can be expected that in the time range of less than one second, the PEG chains are coordinated towards the water when condensed water rests on the PDMS surface and hence cause the spreading effect. If no water is present but a PDMS-containing atmosphere, the PDMS layer then representing the surface dissolves contaminants in itself.

Without wishing to be bound to this working hypothesis, it has been found that compounding of block copolymers in the manner described is suitable for the formation of coatings which adhere well to polycarbonate and that this coating, in contrast to other known layers, is contamination-tolerant with respect to materials present in headlamps and permanently maintains a water-spreading effect. Furthermore, this layer does not need to be “developed” specially in water first, as required by other layers made from block copolymers bound to PEG and existing below their glass temperature. The layer is clearly transparent.

1. Coating composition for the production of a hydrophilic coating on a plastic substrate comprising phase-segregated compartments of the following compound classes:
a) at least one polyaromatic block having a molecular weight of about 1,000 to about 20,000 g/mole,
b) at least one polyorganosiloxane block having a molecular weight of about 200 to about 50,000 g/mole and
c) at least one hydrophilic polyether block having a molecular weight of about 100 to about 50,000 g/mole.

2. Coating composition according to claim 1, characterised in that it also comprises
d) at least one polyolefin block having a molecular weight of about 2,000 to about 500,000 g/mole.

3. Coating composition according to claim 1, characterised in that at least one hydrophilic polyether of compound class c) comprises a polyethylene glycol or a copolycondensate of ethylene glycol with other polyhydric alcohols.

4. Coating composition according to one of claim 1, characterised in that it comprises polyaromatic blocks a) having a molecular weight of about 4,000 to about 10,000 g/mole.

5. Coating composition according to one of claim 1, characterised in that it comprises polyorganosiloxane blocks, preferably polydimethylsiloxane blocks b), having a molecular weight of about 500 to about 5,000 g/mole.

6. Coating composition according to one of claim 1, characterised in that it comprises hydrophilic polyether blocks c), preferably polyethylene glycol blocks, having a molecular weight of about 500 to about 2,000 g/mole.

7. Coating composition according to one of claim 1, characterised in that it comprises polyolefin blocks d) having a molecular weight of about 20,000 to about 100,000 g/mole.

8. Coating composition according to one of claim 1, characterised in that it comprises a polymer, the hydrophilic groups of which are bound to an elastomeric phase which has an intrinsic glass transition as a maximum of the loss modulus at ω=10/s determined at temperatures less than −10° C.

9. Coating composition according to one of claim 1, characterised in that it comprises a polymer, the elastomeric phase of which is bound to a hard phase which is present in the glass state at room temperature and which has an intrinsic glass transition as a maximum of the loss modulus at ω=10/s determined at temperatures greater than 50° C.

10. Coating composition according to one of claim 1, characterised in that it comprises a polymer having double-phase nature which can be detected by dynamic-mechanical spectroscopy.

11. Coating composition according to one of claim 1, characterised in that it comprises a polymer which is contamination-tolerant with respect to PDMS (polydimethylsiloxane).

12. Coating composition according to one of claim 1, characterised in that it comprises at least one styrene block copolymer of the type A-B-A with elastomeric central blocks.

13. Coating composition according to one of claim 1, characterised in that the polymer was produced starting from a styrene block copolymer grafted with maleic acid anhydride.

14. Coating composition according to one of claim 1, characterised in that the polymer is produced starting from an amine-containing PDMS-PEG copolymer.

15. Coating composition according to one of claim 1, characterised in that it comprises at least one stabiliser to degradation by elevated temperature, preferably at least one sterically hindered phenol or amine.

16. Coating composition according to one of claim 1, characterised in that it comprises at least one light-protecting agent, preferably benzotriazole.

17. Coating composition according to one of claim 1, characterised in that it comprises at least one resin which is soluble predominantly in one of the phases, preferably an aliphatic hydrocarbon polymer for the elastomeric phase, optionally having low aromatic content or an aromatic resin having a molecular weight which is not above double the molecular weight of the polystyrene blocks of the block copolymer.

18. Coating composition according claim 1, characterised in that it contains a solvent at least initially.

19. Use of a coating composition according to one of claim 1 as a hydrophilic coating on a substrate which comprises polycarbonate.

20. Use of a coating composition according to one of claim 1 for coating motor vehicle parts, in particular plastic end plates in motor vehicle headlamps.

21. Motor vehicle part, characterised in that it has at least partly a coating produced using a coating composition according to one of claim 1.

22. A motor vehicle headlamp or part thereof characterized in that it has at least partly a coating produced using a coating composition according to claim 1.
